(19) United States
(12) Patent Application Publication
(10) Pub. No.: US 2013/0026980 A1
(43) Pub. Date: Jan. 31, 2013

(54) ELECTRONIC INSTRUMENT AND ELECTRONIC TIMEPIECE

(71) Applicant: Yoshinori SUGAI, Chiba-shi (JP)

(72) Inventor: Yoshinori SUGAI, Chiba-shi (JP)

(21) Appl. No.: 13/559,716

(22) Filed: Jul. 27, 2012

(30) Foreign Application Priority Data
Jul. 28, 2011 (JP) 2011-165290

(51) Int. Cl. H02J 7/00

(52) U.S. Cl. 320/107

(57) ABSTRACT

Notification of a charging trend of a secondary cell is achieved with a simpler configuration. A solar cell charges a secondary cell. A CPU detects voltage values of the secondary cell at a predetermined cycle and determines increase and decrease of the charged amount of the secondary cell on the basis of the result of comparison of the voltage values detected a plurality of number of times. The CPU also displays information indicating increase and decrease of the determined charged amount of the secondary cell on a display unit.

### TECHNICAL FIELD

The present invention relates to an electronic instrument and an electronic timepiece.

### DESCRIPTION OF THE RELATED ART

A solar timepiece configured to display charged amounts simply in three levels of “H”, “M”, and “L” or the like as a method of displaying the charged amount of a secondary cell is known. However, since this display method indicates the charged amount at a time point of display, a user can hardly figure out a charging trend of the secondary cell. Therefore, the user can hardly determine whether positive charging such as exposing the solar timepiece to sun should be done or only using the solar timepiece as-is sufficient.

As an electronic timepiece which solves this problem, there is a known electronic timepiece which is configured to obtain energy balance by an input/output energy amount detecting unit configured to detect an input energy amount and an output energy amount and notifies the variation trend of the energy amount (for example, see JP-A-11-52035).

However, in the electronic timepiece described in JP-A-11-52035, there is a problem in that a specific circuit for detecting the input/output energy amount is necessary. In addition, there is a problem in that a large number of times of measurement of the input/output energy amount are required in order to determine the variation trend of the energy amount, and hence a large amount of power is consumed.

### SUMMARY OF THE INVENTION

It is an aspect of the present application to provide an electronic instrument and an electronic timepiece which is capable of notifying a charging trend of a secondary cell in a simpler configuration.

There is provided an electronic instrument including: a rechargeable secondary cell; a charging unit configured to charge the secondary cell; a display unit; a voltage detecting unit configured to detect voltage values of the secondary cell at a predetermined cycle; a charging trend determining unit configured to determine increase and decrease of the charged amount of the secondary cell on the basis of the result of comparison among the voltage values detected by a plurality of number of times by the voltage detecting unit; and a display control unit configured to display information indicating the increase and decrease of the charged amount of the secondary cell determined by the charging trend determining unit on the display unit.

Preferably, the predetermined cycle is one-day cycle, and the charging trend determining unit compares the voltage detected by the voltage value detecting unit and the voltage value detected one day before the corresponding detection, and determines increase and decrease of the charged amount of the secondary cell.

Preferably, every time when the voltage detecting unit detects the voltage values a predetermined number of times, the charging trend determining unit calculates an average value of the voltage values detected by the number of times of detection, and determines increase and decrease of the charged amount of the secondary cell on the basis of the result of comparison of the calculated average values.

Preferably, the predetermined cycle is one-day cycle, and the predetermined number of times is seven times.

The application also provides an electronic timepiece including: a rechargeable secondary cell; a charging unit configured to charge the secondary cell; a display unit; a voltage detecting unit configured to detect voltage values of the secondary cell at a predetermined cycle; a charging trend determining unit configured to determine increase and decrease of the charged amount of the secondary cell on the basis of the result of comparison among the voltage values detected by a plurality of number of times by the voltage detecting unit; and a display control unit configured to display information indicating the increase and decrease of the charged amount of the secondary cell determined by the charging trend determining unit on the display unit.

According to the application, the charging unit charges the secondary cell. The voltage detecting unit detects the voltage value of the secondary cell at the predetermined cycle. The charging trend determining unit determines increase and decrease of the charged amount of the secondary cell on the basis of the result of comparison of the voltage values that the voltage detecting unit detects by a plurality of number of times. The display control unit displays the information indicating increase and decrease of the charged amount of the secondary cell determined by the charging trend determining unit on the display unit. Accordingly, the increase and decrease of the charged amount of the secondary cell is determined by detecting the voltage value of the secondary cell at the predetermined cycle so that the result of determination can be displayed. Therefore, the charging trend of the secondary cell can be notified in a simpler configuration.

### BRIEF DESCRIPTION OF THE DRAWINGS

FIG. 1 is a block diagram showing a configuration of an electronic timepiece in a first embodiment of the invention;

FIG. 2 is a circuit drawing showing a circuit configuration including a power unit, a solar cell, a reverse flow preventing circuit and an overcharge preventing circuit in the first embodiment of the invention;

FIGS. 3A to 3C are schematic drawings of display contents indicating charging trends of a secondary cell in the first embodiment of the invention;

FIGS. 4A to 4C are schematic drawings of display contents indicating charging trends of the secondary cell in the first embodiment of the invention;

FIGS. 5A to 5C are schematic drawings of display contents indicating charging trends of the secondary cell in the first embodiment of the invention;

FIGS. 6A to 6C are schematic drawings of display contents indicating charging trends of the secondary cell in the first embodiment of the invention;

FIG. 7 is a flowchart showing a process procedure of a charging trend display process executed by the electronic timepiece in the first embodiment of the invention;

FIG. 8 is a graph showing voltage values of the secondary cell that the electronic timepiece in the first embodiment of the invention detects every day in the charging trend display process;

FIG. 9 is a graph showing voltage values of the secondary cell that the electronic timepiece in the first embodiment of the invention detects every day in the charging trend display process; and

FIG. 10 is a flowchart showing a process procedure of a charging trend display process executed by the electronic timepiece in a second embodiment of the invention.

### DESCRIPTION OF THE PREFERRED EMBODIMENTS

### First Embodiment

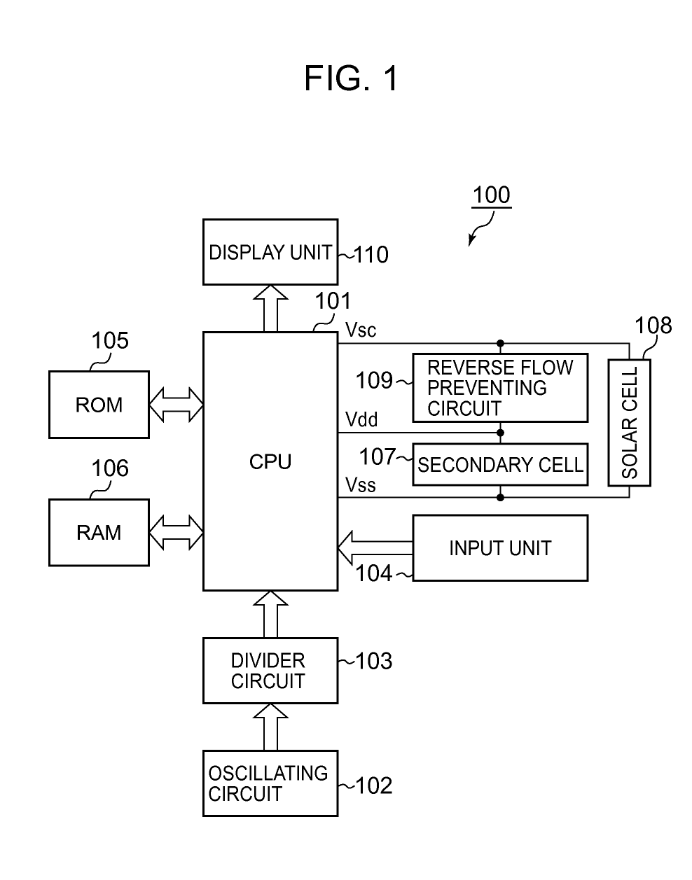

Referring now to the drawings, a first embodiment of the invention will be described. In the first embodiment, an example of an electronic timepiece provide with a solar cell will be described as an example of an electronic instrument. FIG. 1 is a block diagram showing a configuration of the electronic timepiece in the embodiment. In an illustrated example, an electronic timepiece 100 includes a CPU 101 (voltage detecting unit, charging trend determining unit, display control unit), an oscillating circuit 102, a divider circuit 103, an input unit 104, a ROM (Read Only memory) 105, a RAM (Random Access Memory) 106, a secondary cell 107, a solar cell 108 (charging unit), a reverse flow preventing circuit 109, and a display unit 110.

The CPU 101 performs control of respective components provided in the electronic timepiece 100. The CPU 101 is configured to detect the voltage of the secondary cell 107. The CPU 101 is configured to determine increase and decrease of the charged amount of the secondary cell 107. The CPU 101 is configured to control the display of the display unit 110. The oscillating circuit 102 outputs a signal having a predetermined frequency. The divider circuit 103 divides the output signal from the oscillating circuit 102 by a predetermined dividing ratio and outputs a reference clock signal for the CPU 101 or a clock signal for time keeping. The input unit 104 includes a switch which allows operation from the outside, and receives an input. The ROM 105 stores a program to be executed by the CPU 101 in advance. The RAM 106 stores data used by the electronic timepiece 100.

The secondary cell 107 is a rechargeable cell, and supplies power to respective components of the electronic timepiece 100. The voltage output from the secondary cell 107 (output voltage) is high when the remaining battery level (charged amount) is large, and is reduced as the remaining battery level is lowered. Accordingly, the remaining battery level of the secondary cell 107 can be detected on the basis of the value of the voltage output from the secondary cell 107 (output voltage value).

The solar cell 108 generates power according to the intensity of received light, and charges the secondary cell 107. The reverse flow preventing circuit 109 is a circuit configured to control an electric current so as not to flow from the secondary cell 107 to the solar cell 108. The display unit 110 is, for example, a liquid crystal display, and displays information including time-of-day and a charging trend of the secondary cell.

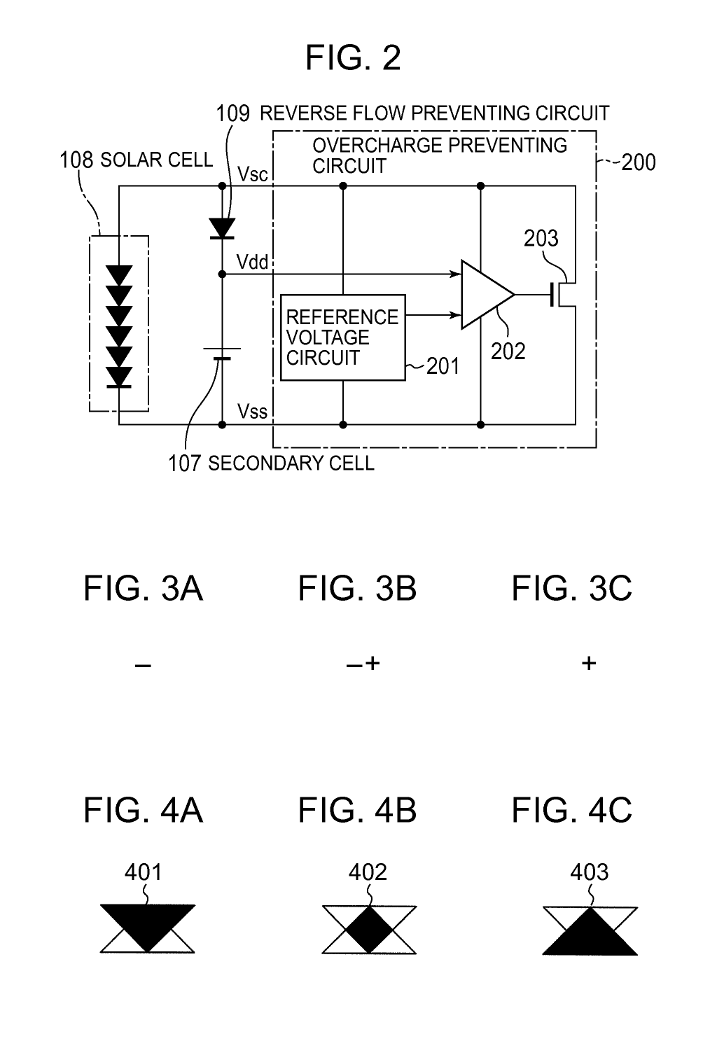

Subsequently, a circuit configuration of the electronic timepiece 100 including the secondary cell 107, the solar cell 108, the reverse flow preventing circuit 109, and an overcharge preventing circuit 200 will be described. FIG. 2 is a circuit drawing showing the circuit configuration of the electronic timepiece 100 in the first embodiment including the secondary cell 107, the solar cell 108, the reverse flow preventing circuit 109, and the overcharge preventing circuit 200. The overcharge preventing circuit 200 is part of the CPU 101. The overcharge preventing circuit 200 includes a reference voltage circuit 201, a comparator unit 202, and a NMOS transistor 203.

In the illustrated example, an anode terminal of the solar cell 108 is connected to a power line Vsc, and a cathode terminal thereof is connected to a power line Vss. An anode terminal of the secondary cell 107 is connected to a power line Vdd, and a cathode terminal thereof is connected to the power line Vss. The reverse flow preventing circuit 109 is a diode element, and an anode terminal thereof is connected to the power line Vsc and a cathode terminal thereof is connected to the power line Vdd. In this configuration, the electric current is prevented from flowing from the secondary cell 107 to the solar cell 108.

One end of an input terminal of the comparator unit 202 is connected to the power line Vdd, and the other end thereof is connected to the reference voltage circuit 201. An output terminal of the comparator unit 202 is connected to a gate terminal of the NMOS transistor 203. A source terminal of the NMOS transistor 203 is connected to the power line Vss, and a drain terminal thereof is connected to the power line Vsc.

The reference voltage circuit 201 inputs a reference voltage to the comparator unit 202. The reference voltage is a voltage of 2.6V which is output, for example, when the secondary cell 107 is full charged. The comparator unit 202 compares the voltage of the power line Vdd with the reference voltage, and outputs a voltage from the output terminal when the voltage of the power line Vdd is a voltage equal to or higher than the reference voltage. Accordingly, when the voltage of the power line Vdd is a voltage equal to or higher than the reference voltage, that is, when the secondary cell 107 is fully charged, an electric current generated by the solar cell 108 does not flow through the secondary cell 107, but flows through the NMOS transistor 203. Therefore, overcharge of the secondary cell 107 can be prevented.

Subsequently, the display contents showing the charging trend of the secondary cell 107 displayed on the display unit 110 will be described. FIGS. 3A to 3C are schematic drawings showing the display contents indicating the charging trend of the secondary cell 107 displayed on the display unit 110 in this embodiment. A sign “−” in FIG. 3A indicates that the charged amount of the secondary cell 107 is reducing, that is, the amount of consumed power is larger than the amount of charging power. The sign “−+” in FIG. 3B indicates that the charged amount of the secondary cell 107 is not changing, that is, the amount of charging power and the amount of consumed power are the same. The sign “+” in FIG. 3C indicates that the charged amount of the secondary cell 107 is increasing, that is, the amount of charging power is larger than the amount of consumed power. A user learns the charging trend of the secondary cell 107 by viewing the signs displayed on the display unit 110. Therefore, the user can determine easily whether positive charging of the secondary cell 107 such as exposing the electronic timepiece 100 to sun should be done or only using the electronic timepiece 100 as-is sufficient.

For example, when the display unit 110 displays the sign “−” shown in FIG. 3A, the user leans that the charged amount of the secondary cell 107 is reducing. Therefore, the user can easily determine that the secondary cell 107 is better to be charged positively. When the display unit 110 displays the sign “−+” shown in FIG. 3B, the user leans that the charged amount of the secondary cell 107 is not changing. Therefore, the user can easily determine that the secondary cell 107 needs not to be positively charged because the charged amount of the secondary cell 107 is not reduced even when the electronic timepiece 100 is used as in the past. When the display unit 110 displays the sign “+” shown in FIG. 3C, the user leans that the charged amount of the secondary cell 107 is increasing. Therefore, the user is capable of charging the secondary cell 107 and hence is capable of determining that it is better to use the electronic timepiece 100 as in the past.

The display contents showing the charging trend of the secondary cell 107 displayed on the display unit 110 are not limited to those shown in FIGS. 3A to 3C. Subsequently, examples of the display contents showing the charging trends of the secondary cell 107 displayed on the display unit 110 will be described with reference to FIG. 4A to FIG. 6C.

A graphic 401 in FIG. 4A is a sign indicating that the charged amount of the secondary cell 107 is reducing. A graphic 402 in FIG. 4B is a sign indicating that the charged amount of the secondary cell 107 is not changing. A graphic 403 in FIG. 4C is a sign indicating that the charged amount of the secondary cell 107 is increasing.

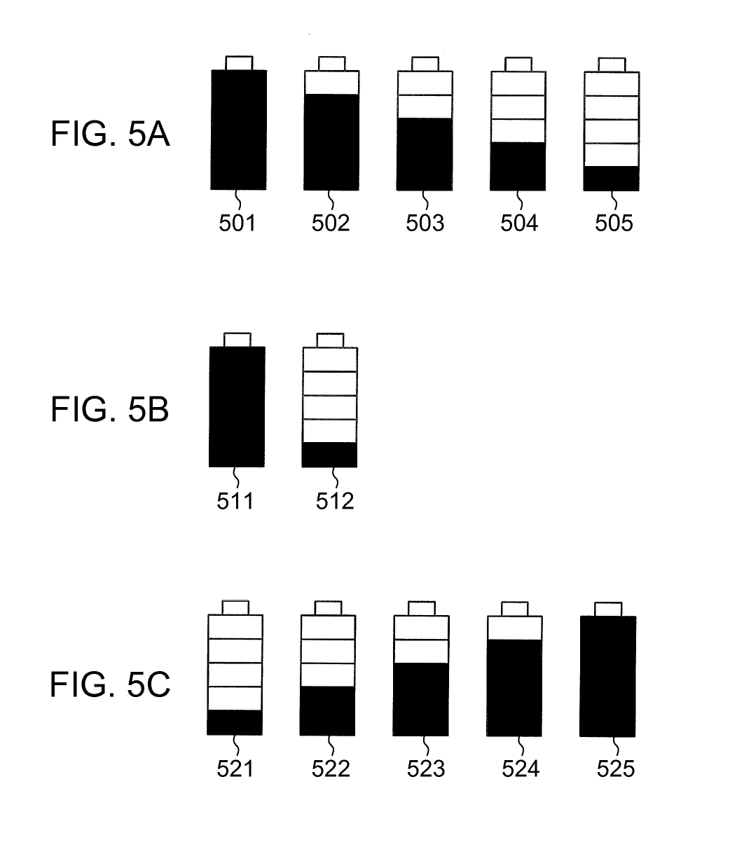

The charging trend of the secondary cell may be indicated by using a dynamic display instead of a static display. For example, as shown in FIG. 5A, by changing the signs in the order of a battery mark 501, a battery mark 502, . . . a battery mark 505, the battery mark 501, . . . at every certain period (for example, every second), the state that the charged amount of the secondary cell 107 is reducing may be shown. Also, as shown in FIG. 5B, the state that the charged amount of the secondary cell 107 is not changed may be shown by displaying a battery mark 511 and a battery mark 512 alternately at every certain period. As shown in FIG. 5C, by changing the signs in the order of a battery mark 521, a battery mark 522, . . . a battery mark 525, the battery mark 521, . . . at every certain period, the state that the charged amount of the secondary cell 107 is increasing may be shown.

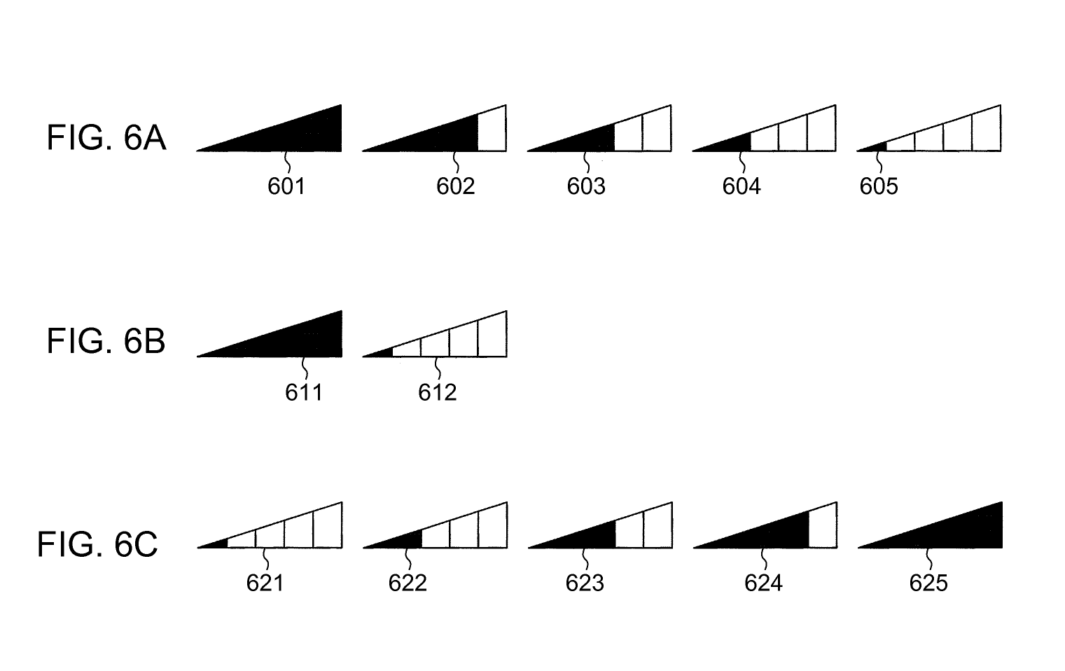

Not only the battery marks, other graphics may be displayed dynamically to show the charging trend of the secondary cell. For example, as shown in FIG. 6A, by changing the signs in the order of a graphic 601, a graphic 602, . . . a graphic 605, the graphic 601, . . . at every certain period, the state that the charged amount of the secondary cell 107 is reducing may be shown. Also, as shown in FIG. 6B, the state that the charged amount of the secondary cell 107 is not changed may be shown by displaying a graphic 611, a graphic 612 alternately at every certain period. Also, as shown in FIG. 6C, by changing the signs in the order of a graphic 621, a graphic 622, . . . a graphic 625, the graphic 621, . . . at every certain period, the state that the charged amount of the secondary cell 107 is increasing may be shown.

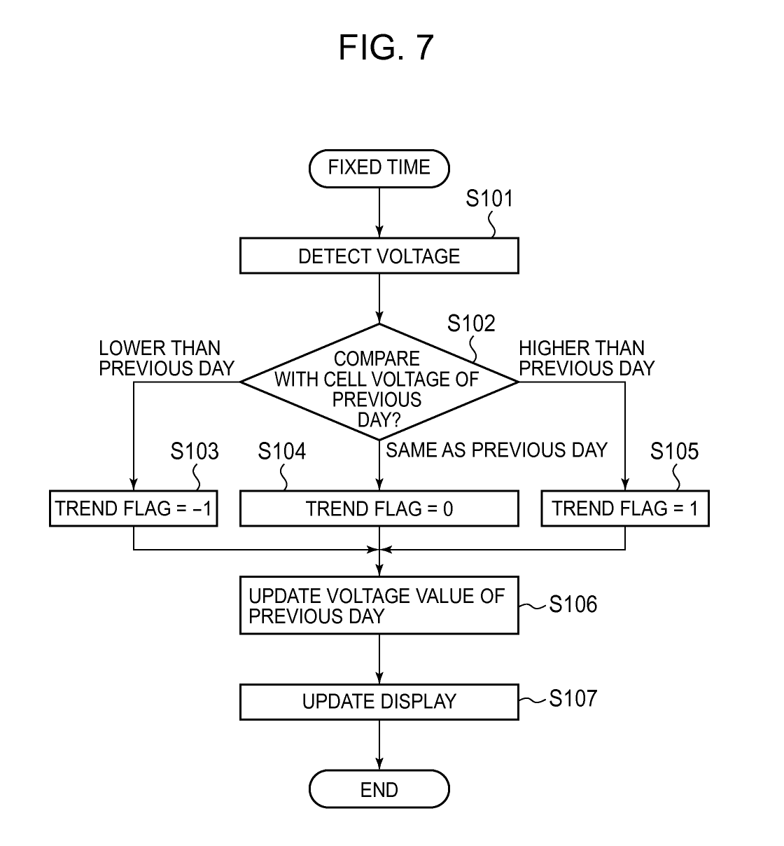

Subsequently, a charging trend display process that the electronic timepiece 100 displays the charging trend of the secondary cell 107 on the display unit 110 in the first embodiment will be described. FIG. 7 is a flowchart showing a process procedure of the charging trend display process for the electronic timepiece 100 in the embodiment. The electronic timepiece 100 executes the charging trend display process once a day at a fixed time. For example, the electronic timepiece 100 executes the charging trend display process at 3 o'clock in the morning when the probability that the user uses the electronic timepiece 100 is low.

(Step S101) The CPU 101 detects the voltage value of the secondary cell 107. Subsequently, the procedure goes to the process in Step S102.

(Step S102) The CPU 101 compares the voltage value of the secondary cell 107 detected in the process in Step S101 and the “voltage value of the previous day” updated when the charging trend display process is executed in the previous day and stored in the RAM 106, and determines which one of the voltage values is a high (low) voltage value. When the CPU 101 determines that the voltage value detected in Step S101 is lower than the “voltage value of the previous day”, the procedure goes to the process in Step S103. When the CPU 101 determines that the voltage value detected in Step S101 is the same as the “voltage value of the previous day”, the procedure goes to the process in Step S104. When the CPU 101 determines that the voltage value detected in Step S101 is higher than the “voltage value of the previous day”, the procedure goes to the process in Step S105. When the charging trend display process for the first time is executed because the electronic timepiece 100 is activated or reset or the like, the “voltage value of the previous day” is not stored in the RAM 106. Therefore, the CPU 101 stores the voltage value detected in the process in Step S101 in the RAM 106 as the “voltage value of the previous day” and the charging trend display process is terminated.

(Step S103) The CPU 101 updates the value of the trend flag stored in the RAM 106 to “−1”. Subsequently, the procedure goes to the process in Step S106.

(Step S104) The CPU 101 updates the value of the trend flag stored in the RAM 106 to “0”. Subsequently, the procedure goes to the process in Step S106.

(Step S105) The CPU 101 updates the value of the trend flag stored in the RAM 106 to “1”. Subsequently, the procedure goes to the process in Step S106.

(Step S106) The CPU 101 updates the “voltage value of the previous day” stored in the RAM 106 to the voltage value of the secondary cell 107 detected in the process in Step S101. Subsequently, the procedure goes to the process in Step S107.

(Step S107) The CPU 101 displays the display contents showing the charging trend of the secondary cell 107 on the display unit 110 on the basis of the value of the trend flag stored in the RAM 106. More specifically, when the value of the trend flag stored in the RAM 106 is “−1”, the CPU 101 displays the display contents indicating that the charged amount of the secondary cell 107 is reducing on the display unit 110. Also, when the value of the trend flag stored in the RAM 106 is “0”, the CPU 101 displays the display contents indicating that the charged amount of the secondary cell 107 does not change on the display unit 110. Also, when the value of the trend flag stored in the RAM 106 is “1”, the CPU 101 displays the display contents indicating that the charged amount of the secondary cell 107 is increasing on the display unit 110. Subsequently, the charging trend display process is terminated.

As described above, in this embodiment, the CPU 101 detects the voltage value of the secondary cell 107 once a day at a fixed time. Then, the CPU 101 determines the charging trend of the secondary cell 107 by comparing the voltage value detected on the current day and the voltage value detected on the previous day. More specifically, the CPU 101 determines the charged amount of the secondary cell 107 is reducing when the voltage value detected on the previous day is higher than the voltage value detected on the current day. Also, the CPU 101 determines the charged amount of the secondary cell 107 does not change when the voltage value detected on the current day is the same as the voltage value detected on the previous day. Also, the CPU 101 determines the charged amount of the secondary cell 107 is increasing when the voltage value detected on the previous day is lower than the voltage value detected on the current day.

The CPU 101 displays the display contents showing the charging trend of the secondary cell 107 on the display unit 110. Accordingly, the user learns the charging trend of the secondary cell 107 by viewing the display contents displayed on the display unit 110. Therefore, the user can determine easily whether positive charging of the secondary cell 107 such as exposing the electronic timepiece 100 to sun should be done or only using the electronic timepiece 100 as-is sufficient.

The electronic timepiece 100 detects only the voltage value of the secondary cell 107, and determines the charging trend of the secondary cell 107 using the detected voltage value. Therefore, the electronic timepiece 100 is capable of determining the charging trend of the secondary cell 107 without using the specific circuit for detecting the input/output energy amount which has been required in the related art. Therefore, the electronic timepiece 100 is capable of notifying the charging trend of the secondary cell to the user in a simpler configuration.

Also, since the electronic timepiece 100 displays the display contents indicating the charging trend on the display unit 110, the charging trend can be notified to the user even when the display contents do not change with the display indicating the remaining battery level of the secondary cell by the three levels of “H”, “M”, and “L” in the related art.

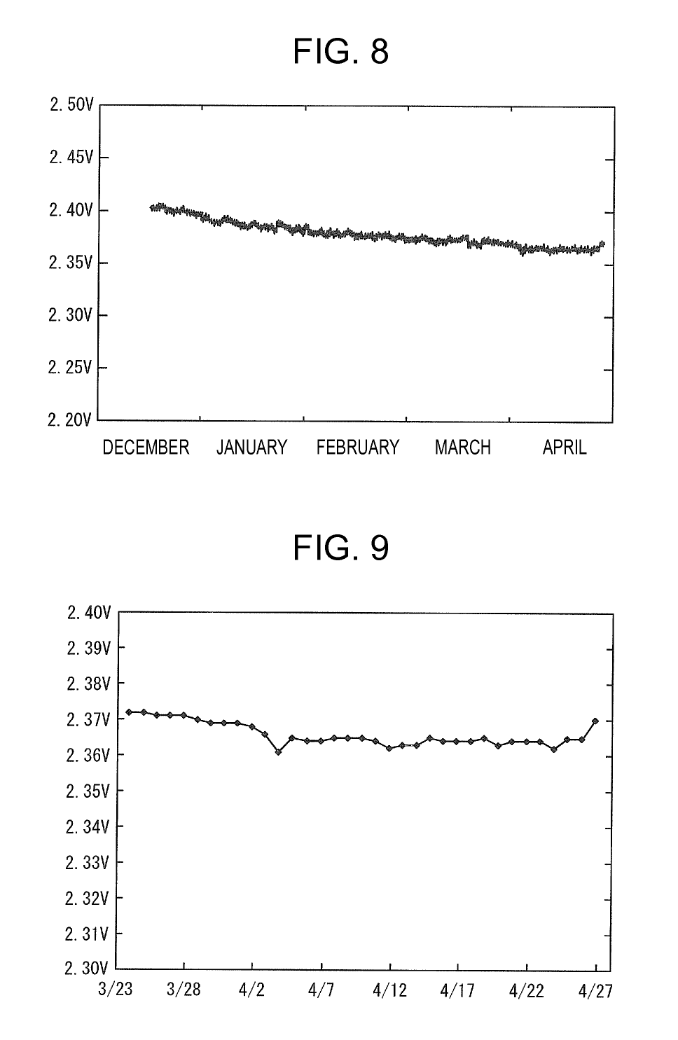

FIG. 8 is a graph showing voltage values of the secondary cell 107 that the electronic timepiece, 100 in the first embodiment detects every day in the charging trend display process from December to April. Also, FIG. 9 is a graph showing voltage values of the secondary cell 107 that the electronic timepiece 100 in the first embodiment detects every day in the charging trend display process from March 23rd to April 27th.

As illustrated, although the voltage values of the secondary cell 107 are different every day, the voltage value of the secondary cell 107 falls within a range from 2.35V to 2.45V. Therefore, in the method of displaying in three levels in the related art, in a case where the mark “H” is displayed when the voltage value of the secondary cell is 2.45V or higher, the mark “M” is displayed when the voltage value of the secondary cell is from 2.35V to a value smaller than 2.45V, and the mark “L” is displayed when the voltage value of the secondary cell is smaller than 2.35V, the electronic timepiece always displays “M” even though the voltage value of the secondary cell varies every day. Therefore, in the method of displaying in three levels in the related art, the user cannot learn the charging trend of the secondary cell.

However, the electronic timepiece 100 in the first embodiment compares the voltage value of the previous day and the voltage value of the current day to determine the charging trend of the secondary cell 107, and displays the display contents indicating the charging trend on the display unit 110. Therefore, the user can learn the charging trend of the secondary cell 107 also when the display contents do not change with the display indicating the remaining battery level of the secondary cell by the three levels of “H”, “M”, and “L” in the related art.

### Second Embodiment

Referring now to the drawings, a second embodiment of the invention will be described. The electronic timepiece 100 in the second embodiment has the same configuration as the electronic timepiece 100 in the first embodiment. The second embodiment is different from the first embodiment in the period in which the charging trend is determined. The electronic timepiece 100 in the first embodiment determines the charging trend every day. However, the electronic timepiece 100 in the second embodiment calculates an average value of the voltage values obtained by a plurality of number of times of detection of the voltage values of the secondary cell 107, and determines the charging trend of the secondary cell 107 on the basis of the calculated average value. For example, when determining the charging trend every week by detecting the voltage value of the secondary cell 107 once a day, the average value of the voltage values obtained by seven times of detection is calculated every time when the voltage values of the secondary cell 107 are detected seven times, and the charging trend of the secondary cell 107 is determined on the basis of the calculated average value.

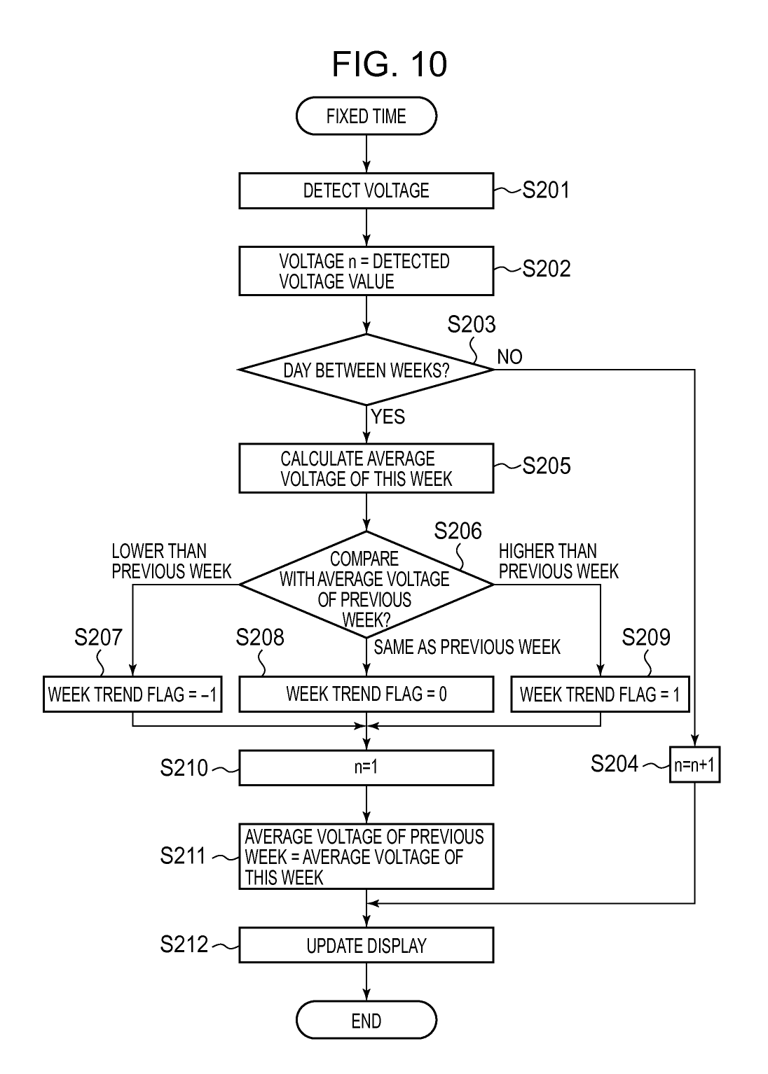

The charging trend display process that the electronic timepiece 100 displays the charging trend of the secondary cell 107 on the display unit 110 according to the second embodiment will be described below. FIG. 10 is a flowchart showing a process procedure of the charging trend display process for the electronic timepiece 100 according to the second embodiment. Description will be given on a case where the charging trend display process is executed once a day at a fixed time and the charging trend of the secondary cell 107 is determined every week.

(Step S201) The CPU 101 detects the voltage value of the secondary cell 107. Subsequently, the procedure goes to the process in Step S202.

(Step S202) The CPU 101 stores the voltage value of the secondary cell 107 detected in the process in Step S101 in the RAM 106 as “voltage value n”. Subsequently, the procedure goes to the process in Step S203. The value of n is stored in the RAM 106.

(Step S203) The CPU 101 determines whether or not the current day is a day between weeks (for example, Sunday). When the CPU 101 determined that the current day is the day between weeks, the procedure goes to the process in Step S205, and in other cases, the procedure goes to the process in Step S204. The day between weeks may be determined in advance, or may be configured to be set by the user arbitrarily.

(Step S204) The CPU 101 reads the value of n stored in the RAM 106 and adds “1”. Then, the CPU 101 stores the value after addition as the value of n in the RAM 106. Subsequently, the procedure goes to the process in Step S212.

(Step S205) The CPU 101 calculates an “average voltage value of this week”. More specifically, the CPU 101 calculates an average value of “voltage value 1” to “voltage value 7” stored in the RAM 106. Subsequently, the procedure goes to the process in Step S206.

(Step S206) The CPU 101 compares the “average voltage value of this week” calculated in the process of Step S205 and the “average voltage value of the previous week” stored in the RAM 106, and determines which one of the voltage values is a high (low) voltage value. When the CPU 101 determines that the “average voltage value of this week” calculated in the process of Step S205 is lower than the “average voltage value of the previous week”, the procedure goes to the process in Step S207. Also, when the CPU 101 determines that the “average voltage value of this week” calculated in the process of Step S205 and the “average voltage value of the previous week” are the same voltage value, the procedure goes to the process in Step S208. When the CPU 101 determines that the “average voltage value of this week” calculated in the process of Step S205 is higher than the “average voltage value of the previous week”, the procedure goes to the process in Step S209. When the “average voltage value of the previous week” is not stored in the RAM 106 because the electronic timepiece 100 is activated or reset or the like, the CPU 101 stores the “average voltage value of this week” calculated in the process of Step S205 in the RAM 106 as the “average voltage value of the previous week”, and the charging trend display process is terminated.

(Step S207) The CPU 101 updates the value of the week trend flag stored in the RAM 106 to “−1”. Subsequently, the procedure goes to the process in Step S210.

(Step S208) The CPU 101 updates the value of the week trend flag stored in the RAM 106 to “0”. Subsequently, the procedure goes to the process in Step S210.

(Step S209) The CPU 101 updates the value of the week trend flag stored in the RAM 106 to “1”. Subsequently, the procedure goes to the process in Step S210.

(Step S210) The CPU 101 updates the value of n stored in the RAM 106 to “1”. Subsequently, the procedure goes to the process in Step S211.

(Step S211) The CPU 101 updates the value of the “average voltage value of the previous week” stored in the RAM 106 to the value of the “average voltage value of this week” calculated in the process of Step S205. Subsequently, the procedure goes to the process in Step S212.

(Step S212) The CPU 101 displays the display contents showing the charging trend of the secondary cell 107 on the display unit 110 on the basis of the value of the week trend flag stored in the RAM 106. More specifically, when the value of the week trend flag stored in the RAM 106 is “−1”, the CPU 101 displays the display contents indicating that the charged amount of the secondary cell 107 is reducing on the display unit 110. Also, when the value of the week trend flag stored in the RAM 106 is “0”, the CPU 101 displays the display contents indicating that the charged amount of the secondary cell 107 does not change on the display unit 110. Also, when the value of the week trend flag stored in the RAM 106 is “1”, the CPU 101 displays the display contents indicating that the charged amount of the secondary cell 107 is increasing on the display unit 110. Subsequently, the charging trend display process is terminated.

As described above, in the second embodiment, the CPU 101 detects the voltage value of the secondary cell 107 at a predetermined cycle, for example, once a day at a fixed time. The CPU 101 calculates the “average voltage value of this week”, which is the average value of the voltage value of a week when the voltage values of the secondary cell 107 are detected a predetermined number of times, for example, seven times when the detection is made once every week, and compares the calculated value with the average value of the voltage values of a week calculated in the previous week, that is, the “average voltage value of the previous week”, thereby determining the charging trend of a week of the secondary cell 107. More specifically, the CPU 101 determines the charged amount of the secondary cell 107 is reducing when the “average voltage value of the previous week” is higher than the “average voltage value of this week”. The CPU 101 determines the charged amount of the secondary cell 107 does not change when the “average voltage value of this week” is the same as the “average voltage value of the previous week”. The CPU 101 determines the charged amount of the secondary cell 107 is increasing when the “average voltage value of the previous week” is lower than the “average voltage value of this week”.

The CPU 101 displays the display contents showing the charging trend of the secondary cell 107 on the display unit 110. Accordingly, the user learns the charging trend of the secondary cell 107 for a week by viewing the display contents displayed on the display unit 110. Therefore, the user can determine easily whether positive charging of the secondary cell 107 such as exposing the electronic timepiece 100 to sun should be done or only using the electronic timepiece 100 as-is is sufficient.

The electronic timepiece 100 detects only the voltage value of the secondary cell 107, and determines the charging trend of the secondary cell 107 using the detected voltage value. Therefore, the electronic timepiece 100 is capable of determining the charging trend of the secondary cell 107 without using the specific circuit for detecting the input/output energy amount which has been required in the related art. Therefore, the electronic timepiece 100 is capable of notifying the charging trend of the secondary cell to the user in a simpler configuration.

Also, since the electronic timepiece 100 displays the display contents indicating the charging trend on the display unit 110, the charging trend can be notified to the user even when the display contents do not change with the display indicating the remaining battery level of the secondary cell by the three levels of “H”, “M”, and “L” in the related art.

The entire or part of the functions of the respective components provided in the electronic timepiece 100 in the first embodiment and the second embodiment described above may be realized by recording a program for realizing these functions in a computer readable recording medium and causing a computer system to read the program recorded the recording medium and execute the program. The term “computer system” described here includes hardware such as OS or peripheral equipment or the like.

The term “computer readable recording medium” means portable media such as flexible disks, magneto-optic disks, ROMs, and CD-ROMs, and memory devices such as hard disk integrated in the computer system. Also, the term “computer readable recording medium” may include those which hold the program dynamically for a short time like networks such as internet, or communication lines used for transmitting the program via a communication network such as telephone lines, and those which hold the program for a certain period such as a volatile memory in the interior of the computer system which becomes a server or a client in that case. The above-described program may be those which realize part of the above-described functions, and may be those which can realize the above-described functions in combination with the program already recorded in the computer system.

Although the embodiment of the invention has been described thus far, the invention is not limited to the embodiments shown above, and various modifications may be made without departing the scope of the invention.

For example, the example in which the charging trend for a day or a week of the secondary battery has been described in the embodiment described above, the invention is not limited thereto, and a configuration in which the charging trend of the arbitrary period is determined and is notified to the user is also applicable.

What is claimed is:

1. An electronic instrument comprising:
a rechargeable secondary cell;
a charging unit configured to charge the secondary cell;
a display unit;
a voltage detecting unit configured to detect voltage values of the secondary cell at a predetermined cycle;
a charging trend determining unit configured to determine increase and decrease of the charged amount of the secondary cell on the basis of the result of comparison among the voltage values detected by a plurality of number of times by the voltage detecting unit; and
a display control unit configured to display information indicating the increase and decrease of the charged amount of the secondary cell determined by the charging trend determining unit on the display unit.

2. The electronic instrument according to claim 1, wherein the predetermined cycle is one-day cycle, and
the charging trend determining unit compares the voltage value detected by the voltage detecting unit and the voltage value detected one day before the corresponding detection, and determines increase and decrease of the charged amount of the secondary cell.

3. The electronic instrument according to claim 1, wherein every time when the voltage detecting unit detects the voltage values a predetermined number of times, the charging trend determining unit calculates an average value of the voltage values detected by the number of times of detection, and determines increase and decrease of the charged amount of the secondary cell on the basis of the result of comparison of the calculated average values.

4. The electronic instrument according to claim 3, wherein the predetermined cycle is one-day cycle, and
the predetermined number of times is seven times.

5. An electronic timepiece comprising:
a rechargeable secondary cell;
a charging unit configured to charge the secondary cell;
a display unit;
a voltage detecting unit configured to detect voltage values of the secondary cell at a predetermined cycle;
a charging trend determining unit configured to determine increase and decrease of the charged amount of the secondary cell on the basis of the result of comparison among the voltage values detected by a plurality of number of times by the voltage detecting unit; and
a display control unit configured to display information indicating the increase and decrease of the charged amount of the secondary cell determined by the charging trend determining unit on the display unit.
